(19) United States
(12) Patent Application Publication
(10) Pub. No.: US 2023/0151988 A1
(43) Pub. Date: May 18, 2023

(54) FURNITURE INTENDED FOR AIR PURIFICATION

(71) Applicant: AIRINSPACE, Elancourt (FR)

(72) Inventor: Stéphane CHATENET, Elancourt (FR)

(21) Appl. No.: 17/797,797

(22) PCT Filed: Feb. 4, 2021
(86) PCT No.: PCT/EP2021/052604

§ 371 Date: Aug. 5, 2022

(30) Foreign Application Priority Data
Feb. 7, 2020 (FR) 2001202

(51) Int. Cl. F24F 8/80; B01D 46/62; B01D 46/10; B03C 3/011; B03C 3/019; B03C 3/155; B03C 3/41; F24F 8/108; F24F 13/20; F24F 8/40

(52) U.S. Cl. CPC F24F 8/80; B01D 46/62; B01D 46/10; B03C 3/011; B03C 3/019; B03C 3/155; B03C 3/41; F24F 8/108; F24F 13/20; F24F 8/40; B01D 2273/30; B01D 2267/60; B03C 2201/06; F24F 2221/10

(57) ABSTRACT

Disclosed is a piece of furniture for air purification in the form of a substantially closed cabinet including: an upper purpose tray; side walls in vertical alignment below this tray; an opening in the top of the side walls; an opening in the bottom of the cabinet, in which an opening allows the filtered air to exit; an electrical power source; an air pressurizer connected to the power source, allowing the air to flow through the cabinet; a horizontal filter, parallel to the upper purpose tray and upstream of the air pressurizer; a vertical filter, perpendicular to the upper purpose tray downstream of the air pressurizer, at least 3 cm away from the nearest side wall; a duct between filter downstream of the air pressurizer and the nearest side wall, which duct allows the filtered air to be discharged towards the opening of the bottom part of the cabinet.

### CROSS-REFERENCE TO PRIORITY APPLICATIONS

The present patent application is the U.S. national phase of International Application No. PCT/EP2021/052604 filed Feb. 4, 2021, which designated the U.S. and claims the priority of French patent application FR20/01202 filed on Feb. 7, 2020 the entire contents of each of which are hereby incorporated by reference.

### BACKGROUND OF THE INVENTION

The present invention belongs to the field of air purification, and relates to a piece of furniture for air purification, a method for air filtration, as well as the use of a piece of furniture for air filtration.

### SUMMARY OF THE INVENTION

The inventors have now developed a piece of furniture which, in addition to providing a purpose surface, allows the air in the room in which it is placed to be purified.

A first object of the invention relates to a piece of furniture (10) for air purification and in the form of a substantially closed cabinet comprising:
a) at least one upper purpose tray (11), which preferably has a rectangular outline,
b) side walls (12) in vertical alignment below this tray,
c) at least one opening (14) in the top part of the side walls (12), which allows air (A) to enter the inside of the cabinet,
d) at least one opening (16) in the bottom part of the cabinet, preferably behind the side walls (12), which at least one opening (16) allows the filtered air (B) to exit the cabinet,
e) at least one electrical power source,
f) at least one air overpressurization means (22) connected to the power source and allowing the air (A) to flow through the cabinet,
g) at least one horizontally positioned filter (21), parallel to the upper purpose tray (11) and located upstream of the air overpressurization means (22),
h) at least one vertically positioned filter (23), perpendicular to the upper purpose tray (11) and located downstream of the air overpressurization means (22), which is at least 3 cm away from the nearest side wall (12),
i) at least one duct (15) between the at least one filter (23) located downstream of the air overpressurization means (22) and the nearest side wall (12), which duct (15) allows the filtered air (B) to be discharged towards the opening (16) in the bottom part of the cabinet.

Such a piece of furniture (10) is capable, despite its limited dimensions (maximum height: 1000 mm, maximum width: 800 mm, maximum depth: 600 mm), to efficiently purify the air in a room while being extremely discreet due to the quiet operation resulting from its improved structure.

Advantageously, a piece of furniture (10) according to the invention has a height between 600 mm and 1000 mm, preferably between 800 mm and 950 mm, even more preferably between 850 mm and 900 mm; a width of 500 mm to 800 mm, preferably 550 mm to 700 mm, even more preferably 600 mm to 650 mm; and a depth of 300 mm to 600 mm, preferably 400 mm to 550 mm, even more preferably 450 mm to 500 mm.

Still advantageously, a piece of furniture (10) according to the invention is capable of treating the air of a room with a maximum volume of 100 m³, preferably 80 m³, even more preferably 75 m³.

Advantageously, the air overpressurization means of a piece of furniture (10) according to the invention allows an operating flow rate between 100 and 5000 m³/h, preferably between 200 and 2000 m³/h to be obtained.

According to one particular embodiment, a piece of furniture (10) according to the invention is intended to be placed at a distance from the walls, and all of its side walls (12) comprise an opening in their top part and preferably an opening in the bottom part of the cabinet behind each of them.

According to another particular embodiment, a piece of furniture (10) according to the invention is intended to be placed against a wall, and the side wall (12) intended to be placed against said wall may comprise no opening in its top part and preferably no opening in the bottom part of the cabinet behind it.

Advantageously, at least one of the side walls (12) of a piece of furniture (10) according to the invention is movable and capable of allowing access to the inside of the cabinet, preferably allowing access to and replacement of the filters arranged inside the cabinet.

According to one particular embodiment, a piece of furniture (10) according to the invention comprises at least two vertically positioned filters (23), preferably at least three vertically positioned filters (23), which are perpendicular to the purpose tray and located downstream of the air overpressurization means (22).

According to another particular embodiment, a piece of furniture (10) according to the invention further comprises:
j) at least one ionizer connected to the power source, which ionizer is preferably located between the at least one horizontally positioned filter (21) and the at least one horizontally positioned filter (23).

According to an alternative embodiment, a piece of furniture (10) according to the invention further comprises at least one enclosure (31) connected to the electrical power source.

A second object of the invention relates to an air filtration method characterized in that it comprises at least the following steps:
i) placing a piece of furniture (10) according to the invention in a room, and
ii) starting up the air overpressurization means (22) connected to the power source.

A third object of the invention relates to the use of a piece of furniture (10) according to the invention for air filtration.

### BRIEF DESCRIPTION OF THE DRAWINGS

Other features, details and advantages of the invention will be more clearly apparent from the detailed description given below as an indication in connection with the drawings in which:

FIG. 1 represents one particular embodiment of a piece of furniture (10) according to the invention.

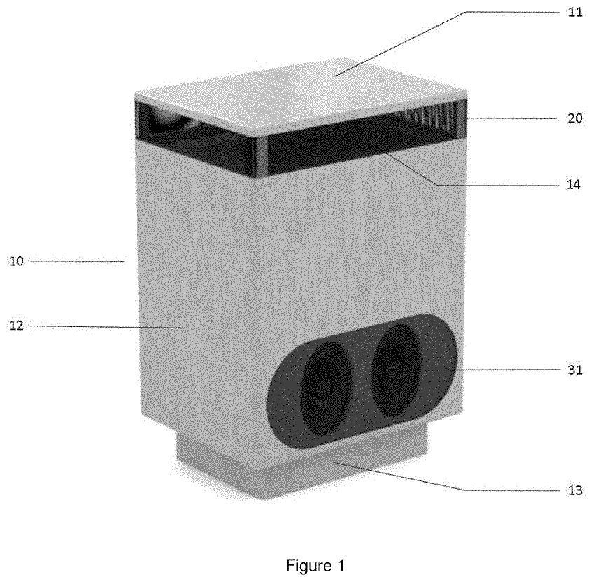

FIG. 2 is a schematic front sectional view of a piece of furniture (10) according to the invention in operation.

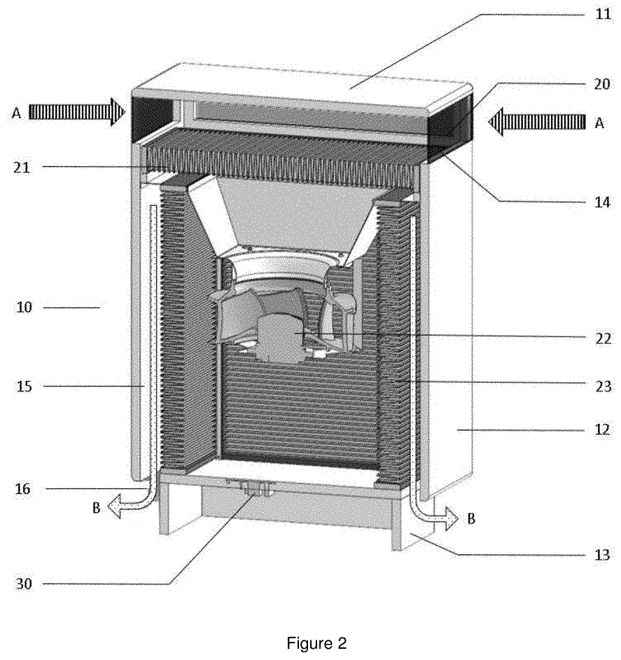

FIG. 3 is a schematic side sectional view of a piece of furniture (10) according to the invention in operation.

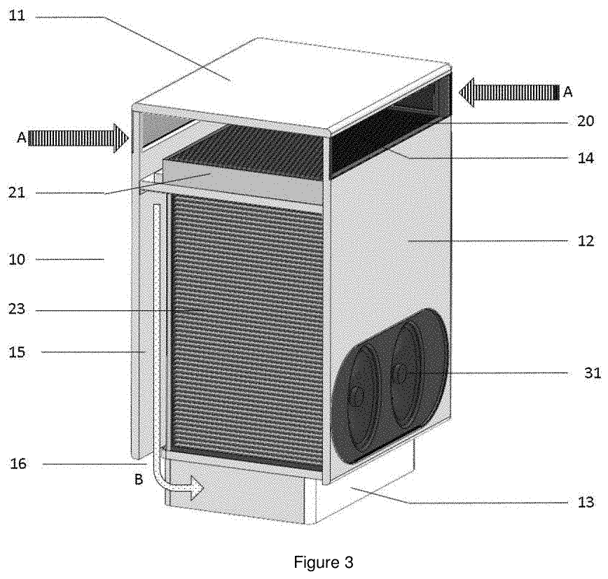

### DESCRIPTION OF THE PREFERRED EMBODIMENTS

According to a first aspect, the invention relates to a piece of furniture (10) for air purification. By “piece of furniture”, within the meaning of the present invention, is meant an object contributing to furnishing and decorating premises, in the form of a substantially closed cabinet. By way of illustration, and in a non-exhaustive manner, a piece of furniture (10) according to the invention may be in the form of a console, a chest of drawers, a stand table, a table, a bedside table, a coffee table, etc.

By “air purification” is meant obtaining good quality ambient air. Good ambient air quality can be assessed on the basis of several parameters, and by way of example on the concentration of volatile organic compounds (VOCs), the concentration of fine particles, such as the concentration of fine particles with a diameter of less than 10 μm (PM 10) and/or the concentration of fine particles with a diameter of less than 2.5 μm (PM 2.5), etc.

A piece of furniture (10) according to the invention comprises an upper purpose tray (11). By “upper purpose tray” is meant a flat surface, preferably with a rectangular outline, for placing, storing or putting away objects by the user. Advantageously, the dimensions of the piece of furniture (10) are selected in such a way that said upper purpose tray (11) is within reach of the user, that is to say at a height between 50 cm and 130 cm, preferably between 60 and 100 cm.

A piece of furniture (10) according to the invention advantageously comprises a stand (13), which constitutes the base on which the piece of furniture (10) according to the invention rests, and the surface of which is smaller than that of the upper purpose tray (11). Advantageously, the length and width of the stand (13) of a piece of furniture (10) according to the invention are smaller than the length and width of the upper purpose tray (11), preferably they are at least 3 cm smaller.

A piece of furniture (10) according to the invention also comprises side walls (12) in vertical alignment below said upper purpose tray (11). There are advantageously four of these side walls (12) and they thus form the side faces of the piece of furniture (10).

According to one particular embodiment, the structural elements of a piece of furniture (10) according to the invention, which are the stand (13), the side walls (12) and the upper purpose tray (11), are made of metal, plastic or wood, preferably wood, and particularly preferably solid wood or plywood, or pressed wood.

Each side wall (12) of a piece of furniture (10) according to the invention comprises in its top part at least one opening (14) capable of allowing air (A) to enter the inside of the cabinet.

According to one particular embodiment, the opening (14) in the top part of each side wall (12) of a piece of furniture (10) according to the invention may comprise a pre-filter (20) capable of allowing air (A) to enter towards the inside of the cabinet and retaining large particles. Such a pre-filter (20) can be made of a flexible foam-like material, for example polyether, or of a fabric.

Advantageously, the lower edge of the side walls (12) of a piece of furniture (10) according to the invention is located at the height of the stand (13) and is not in contact with the floor, so that at least one opening (16) exists between the side walls (12) and the stand (13), said at least one opening (16) allowing the air filtered in the piece of furniture (10) according to the invention to be discharged.

A piece of furniture (10) according to the invention comprises at least one horizontally positioned filter (21), parallel to the upper purpose tray (11). Such at least one filter (21) is located downstream of the openings (14) in the side walls (12) and upstream of the air overpressurization means (22).

A piece of furniture (10) according to the invention comprises at least one vertically positioned filter (23), perpendicular to the upper purpose tray (11) and located downstream of the air overpressurization means (22). Such at least one filter (23) is placed orthogonally to the stand (13), at the ends thereof, and parallel to the nearest side wall (12) in such a way that the space between said at least one vertically positioned filter (23) and said nearest parallel side wall (12) forms a duct (15) with a width of at least 3 cm, which duct is open to the outside at the height of the stand (13) and is capable of allowing the air filtered by the furniture (10) according to the invention to be added and discharged.

Advantageously, the piece of furniture (10) according to the invention comprises at least two vertically positioned filters (23), preferably at least three vertically positioned filters (23), perpendicular to the upper purpose tray (11) and located downstream of the air overpressurization means (22).

Still advantageously, the piece of furniture (10) according to the invention comprises at least one electrical power source, preferably a connection to the domestic electrical network or an accumulator battery. Optionally, the electrical power source can be coupled to a transformer in order to deliver to the different elements of the furniture (10) an electric current having characteristics adapted to their proper operation.

The at least one horizontally positioned filter (21) and the at least one vertically positioned filter (23) of a piece of furniture (10) according to the invention may be of the same nature or of different nature. These filters can be made of one or more porous, fibrous or granular materials or a mixture thereof.

These filters are thick enough to allow effective air filtration. Typically, said filters have a thickness of at least 8 mm, preferably at least 10 mm, and even more preferably at least 15 mm.

Alternatively, said filters may or may not be formed by superimposing several layers of a same material or of different materials. By way of example of an overlay of at least two layers, preferably at least three layers or four layers, and even more preferably at least five or six layers.

Advantageously, the one or more layers of material forming the filter have a linear or V-shaped profile so as to increase the filtration surface.

According to one particular embodiment, the at least one horizontally positioned filter (21) and the at least one vertically positioned filter (23) of a piece of furniture (10) according to the invention may be high-efficiency air filters of the HEPA type. By HEPA filter is meant a device capable of filtering, in one pass, at least 99.97 percent of particles with a diameter greater than or equal to 0.3 μm.

A piece of furniture (10) according to the invention comprises an air overpressurization means (22) capable of allowing air to flow through the cabinet. By “air flowing through the cabinet” is meant the intake of outside air into the cavity of the piece of furniture (10), its passage through the various filters, and its discharge to the outside. Advantageously, such an air overpressurization means (22) can be in the form of a fan or a turbine. Preferably, such an air overpressurization means (22) is a turbine.

Such an air overpressurization means (22) is advantageously connected to the electrical power source.

Still advantageously, the air overpressurization means (22) of a piece of furniture (10) according to the invention is capable of allowing the air to be taken in, passed through the various filters and discharged with an operating flow rate between 100 and 5000 m³/h, preferably between 200 and 2000 m³/h.

According to one particular embodiment, a piece of furniture (10) according to the invention may comprise an ionizer. Such an ionizer is connected to the power source and is preferably located between the at least one horizontally positioned filter (21) and the at least one vertically positioned filter (23).

Advantageously, an ionizer included in a piece of furniture (10) according to the invention can be in the form of at least one corona effect plasma cell comprising a substantially needle-shaped polarized electrode and a ground electrode, arranged opposite the polarized electrode, comprising a cylinder substantially centered on the polarized electrode and a substantially planar porous film perpendicular to the polarized electrode. Such an ionizer is thus capable of generating a plasma through which the air flow would come to pass, thereby electrically charging the particles present in the air so that the latter are retained in at least one electrostatic filter. Such an ionizer is well known to the person skilled in the art.

According to one particular embodiment, said at least one electrostatic filter of an ionizer of a piece of furniture (10) according to the invention is made of a mineral material such as glass or ceramics, and particularly preferably of glass fiber.

By way of example, such an ionizer is described in French patent FR 3065615.

In the case where the furniture (10) according to the invention comprises such an ionizer, the electrical power source shall be selected so as to be able to deliver a voltage sufficient for the ionizer to generate a plasma. It is thus understood that the electrical power source may include a transformer for raising the voltage of the current.

Advantageously, in the case where a piece of furniture (10) according to the invention comprises an ionizer, a piece of furniture (10) according to the invention comprises a filter located downstream of the ionizer capable of retaining the ionized particles in order to allow their degradation by reaction with the ozone created by the ionizer.

Still advantageously, in the case where a piece of furniture (10) according to the invention comprises an ionizer, a piece of furniture (10) according to the invention also comprises a catalyst downstream of said ionizer, capable of decomposing the ozone produced during ionization. Such a catalyst may be selected from activated carbon, zeolite or manganese oxide (MnO₂), which are capable of allowing rapid decomposition of ozone and nitrogen oxides at room temperature. Such a catalyst preferably takes the form of a honeycomb substrate, for example of aluminum, which is coated with manganese oxide. Advantageously, such a honeycomb substrate should be at least 10 mm thick to be sufficiently effective in neutralizing ozone.

According to one particular embodiment, at least one of the side walls (12) is movable and capable of allowing access to the inside of the cabinet, preferably allowing access to and replacement of the filters arranged inside the cabinet.

Said at least one movable side wall (12) may or may not comprise at least one hinge connecting it to the piece of furniture (10) and capable of allowing it to pivot.

Advantageously, said at least one movable side wall (12) comprises a gripping means, for example a handle allowing a user to open the movable side wall (12) in order to access the inside of the cabinet.

Advantageously, no vertical filter is present directly behind said at least one movable side wall (12), which comes into direct contact with the stand (13) at its bottom end. No duct (15), nor opening (16) allowing air to exit is therefore present at the base of such a movable side wall (12).

According to another particular embodiment, the piece of furniture (10) according to the invention comprises a wireless power transmission device connected to the electrical power source. Such a device is preferably included in the upper purpose tray (11). By wireless power transmission device is meant a device capable of transferring energy by electromagnetic coupling (induction). By way of example, such a wireless power transmission device is capable of charging a compatible mobile device, such as a telephone. Advantageously, such a wireless power transmission device meets the IQ standard defined by the WIRELESS POWER CONSORTIUM.

According to one particular embodiment, the piece of furniture (10) according to the invention comprises one enclosure (31) connected to the electrical power source. Such an enclosure (31) consists of at least one loudspeaker mounted on one of the side walls, preferably on the movable side wall (12) if there is such a wall. The piece of furniture (10) can thus advantageously be used as a sound box.

According to one particular embodiment, a piece of furniture (10) according to the invention may include castors. A castor is defined as a small wheel typically mounted in a yoke movable about a vertical axis, capable of allowing the movement of the object to which it is attached. Advantageously, four castors are attached to the stand (13) and allow easy movement of the piece of furniture (10). In a particularly advantageous manner, the castors usable in a piece of furniture (10) according to the invention have a locking means capable of preventing any impromptu movement of the piece of furniture (10).

Advantageously, a piece of furniture (10) according to the invention comprises a switch (30) capable of controlling the electrical power supply to the air purification means of said piece of furniture (10). By “air purification means” is meant the air overpressurization means (22) and the ionizer, if any. Alternatively, such a switch (30) can be operated remotely, for example using a remote control.

Advantageously, a piece of furniture (10) according to the invention includes a programmer. By programmer is meant a mechanical or electronic system, for example a central processing unit, capable of controlling the operation of the air purification means of said piece of furniture (10), for predefined time ranges.

According to one particular embodiment, said switch (30) is a timed switch (30) capable of allowing the user to set the operating time of the air purification means.

According to one alternative embodiment, a piece of furniture (10) according to the invention may comprise at least one sensor capable of measuring the quality of the ambient air. In a non-exhaustive manner, the at least one sensor of a piece of furniture (10) according to the invention may be a volatile organic compound (VOC) sensor, a fine particle sensor, for example a sensor for fine particles with a diameter of less than 10 μm (PM 10) and/or a sensor for fine particles with a diameter of less than 2.5 μm (PM 2.5), a carbon dioxide sensor, a carbon monoxide sensor, an oxygen sensor.

Advantageously, the at least one sensor of a piece of furniture (10) according to the invention transmits the measurements it makes to a central processing unit capable of controlling the operation of the air purification means (the air overpressurization means (22) and the ionizer, if any) when the measured values exceed a predetermined threshold value.

According to a second aspect, the invention relates to an air filtration method characterized in that it comprises at least the following steps:

i) placing a piece of furniture (10) according to the invention in a room, and

ii) starting up the air overpressurization means (22) connected to the power source.

Advantageously, the placement of a piece of furniture (10) according to the invention in a room will be against a wall of said room.

Still advantageously, an air filtration method according to the invention can be effectively implemented in a room with a surface area of less than 75 m², preferably less than 50 m², even more preferably less than 25 m².

By efficient implementation is meant an air filtration method according to the invention obtaining good quality ambient air in a given time. Good ambient air quality can be assessed on the basis of several parameters, and by way of example on the concentration of volatile organic compounds (VOCs), the concentration of fine particles, such as the concentration of fine particles with a diameter of less than 10 μm (PM 10) and/or the concentration of fine particles with a diameter of less than 2.5 μm (PM 2.5), etc.

According to a last aspect, the invention relates to the use of a piece of furniture (10) according to the invention for air filtration.

1. A piece of furniture for air purification and in the form of a substantially closed cabinet comprising
a) at least one upper purpose tray,
b) side walls in vertical alignment below this tray,
c) at least one opening in the top part of the side walls, which allows air to enter the inside of the cabinet,
d) at least one opening in the bottom part of the cabinet, which allows the filtered air to exit the cabinet,
e) at least one electrical power source,
f) at least one air overpressurization means connected to the power source and allowing the air to flow through the cabinet,
g) at least one horizontally positioned filter, parallel to the upper purpose tray and located upstream of the air overpressurization means,
h) at least one vertically positioned filter, perpendicular to the upper purpose tray and located downstream of the air overpressurization means, which is at least 3 cm away from the nearest side wall,
i) at least one duct between the at least one filter located downstream of the air overpressurization means and the nearest side wall, which duct allows the filtered air to be discharged towards the opening of the bottom part of the cabinet.

2. The piece of furniture of claim 1, wherein the air overpressurization means allows an operating flow rate between 100 and 5000 m³/h to be obtained.

3. The piece of furniture according to claim 1, suitable to be placed at a distance from the walls, wherein all of the side walls comprise an opening in the top part.

4. The piece of furniture according to claim 1, wherein at least one of the side walls is movable and capable of allowing access to the inside of the cabinet.

5. The piece of furniture according to claim 1, further comprising at least two vertically positioned filters perpendicular to the upper purpose tray and located downstream of the air overpressurization means.

6. The piece of furniture according to claim 1, further comprising:
j) at least one ionizer connected to the power source.

7. The piece of furniture according to claim 1, further comprising, on the upper purpose tray, at least one wireless power transmission device connected to the electrical power source.

8. The piece of furniture according to claim 1, further comprising at least one enclosure connected to the electrical power source.

9. An air filtration method comprising at least the following steps:
i) placing a piece of furniture as defined in claim 1 in a room, and
ii) starting up the air overpressurization means connected to the power source.

10. (canceled)

11. The piece of furniture of claim 2, wherein the overpressurization means allows an operating flowrate between 200 and 2000 m³/h to be obtained.

12. The piece of furniture according to claim 4, wherein the at least one movable side wall allows access to and replacement of the filters arranged inside the cabinet.

13. The piece of furniture according to claim 5, comprising at three of the vertically positioned filters.

14. The piece of furniture according to claim 6, wherein the at least one ionizer is located between the at least one horizontally positioned filter and the at least one vertically positioned filter.

15. The piece of furniture according to claim 2, suitable to be placed at a distance from the walls, wherein all of the side walls comprise an opening in the top part.

16. The piece of furniture according to claim 2, wherein at least one of the side walls is movable and capable of allowing access to the inside of the cabinet.

17. The piece of furniture according to claim 3, wherein at least one of the side walls is movable and capable of allowing access to the inside of the cabinet.

18. The piece of furniture according to claim 2, further comprising at least two vertically positioned filters perpendicular to the upper purpose tray and located downstream of the air overpressurization means.

19. The piece of furniture according to claim 3, further comprising at least two vertically positioned filters perpendicular to the upper purpose tray and located downstream of the air overpressurization means.

20. The piece of furniture according to claim 4, further comprising at least two vertically positioned filters perpendicular to the upper purpose tray and located downstream of the air overpressurization means.

21. The piece of furniture according to claim 2, further comprising:
j) at least one ionizer connected to the power source.
